(19) United States
(12) Patent Application Publication
(10) Pub. No.: US 2015/0219006 A1
(43) Pub. Date: Aug. 6, 2015

(54) CYLINDER HEAD WITH COUNTERSINK

(71) Applicant: CATERPILLAR ENERGY SOLUTIONS GMBH, Mannheim (DE)

(72) Inventors: Jürgen Bittner, Hockenheim (DE); Robert Böwing, Innsbruck (AT); Michael Braun, Schriesheim (DE); Friedrich Schäfer, Edenkoben (DE)

(73) Assignee: CATERPILLAR ENERGY SOLUTIONS GMBH, Mannheim (DE)

(21) Appl. No.: 14/421,430

(22) PCT Filed: Aug. 13, 2013
(86) PCT No.: PCT/EP2013/002435

§ 371 Date: Feb. 12, 2015

(30) Foreign Application Priority Data
Aug. 17, 2012 (EP) 12180846.3

(51) Int. Cl. F02B 31/00; B23P 15/10; F02F 1/42

(52) U.S. Cl. CPC F02B 31/00; F02F 1/4214; B23P 15/10; F02B 2031/006

(57) ABSTRACT

A cylinder head of a static spark-ignited gas engine may include at least two exhaust ports, at least two inlet ports, at least one cylinder axis, and a bottom side. Each inlet port runs to the bottom side of the cylinder head and may have a valve seat for inlet valve. Each valve seat may have a corresponding center axis. At least one inlet port has a countersink in the border area of the bottom side. The countersink may have an offset axis shifted from the corresponding center axis. The countersink may also have a maximum radius with reference to the corresponding center axis. The maximum radius and a straight line may form an angle φ. The straight line may connect the cylinder axis with the corresponding center axis. The angle φ may fulfill the following condition: 70°<=φ<=110°.

### TECHNICAL FIELD

The present disclosure generally relates to a cylinder head of a static spark-ignited gas engine. In particular, the disclosure relates to a cylinder head comprising at least two exhaust ports and at least two inlet ports. The cylinder head may further comprise at least one cylinder axis and each inlet port may have a valve seat for inlet valves, each of said valve seats having a center axis. At least one inlet port may have a countersink in a border area of the bottom side of the cylinder head. The countersink may have an offset axis shifted from said center axis effecting a swirl flow, wherein a radius RF, RF′ of said countersink has a point M, M′, said point M, M′ being a radial maximum with reference to the center axis.

Further, the present disclosure refers to a method of manufacturing a cylinder head, and to a static spark-ignited gas engine.

In addition, the present disclosure refers to a method of running a static spar-ignited gas engine of the type disclosed herein.

### BACKGROUND

The combustion process in an engine is decisively influenced by the flow in the cylinder. A distinction is made here between macroscopic flow (swirl, tumble) and microscopic flow (turbulence). Swirl is a turbulent flow that has an axis of rotation parallel to the cylinder axis, tumble is a turbulent flow that has an axis of rotation perpendicular to the cylinder axis.

Spark-ignited gas engines typically use a swirl-type combustion process. The swirl is mostly generated by a combination of tangential and spiral inlet ports. The tangential inlet port is arranged such that the gas-air mixture flows into the cylinder tangentially to the cylinder axis and is conducted along the cylinder wall. This generates a rotation of the charge. However, large valve lifts are required to generate a pronounced swirl level. The operating principle of the spiral inlet port is based on generating a swirl in a helical inlet port that continues inside the cylinder. The disadvantages of a spiral inlet port include poor cylinder charge due to high flow losses and the considerable design effort.

The prior art solution, a combination of tangential and spiral inlet ports, generates a certain swirl level that may deviate from the optimum. A solution for fine tuning the swirl level is sought that can be implemented without a great design effort and the associated re-design of the cylinder head.

EP 1 167 700 B1 discloses a valve device of an internal combustion diesel engine including two suction valves and two exhaust valves arranged in a cylinder head, said suction valves having respective axes directed parallel with a cylinder axis, wherein an edge part at a suction air outlet end of a valve seat of each of said suction valves is expanded in a direction along a swirl stream within a combustion chamber of said engine, wherein said edge part at the suction air outlet end of the valve seat of each of the suction valves is expanded so as to extend over a half circumference about an offset axis shifted from said axis of the suction valve.

EP 1 493 910 A1 discloses a cylinder head for an internal combustion engine, comprising a first inlet duct which extends from a first inlet port to a first outlet port, and a second conduit inlet which extends from a second inlet port to a second outlet port and wherein the first and second inlet ducts are shaped so that the gas flow forms a swirling motion around the main axis of the combustion chamber, wherein at least the edge of the first outlet port of the first inlet duct comprises a notched portion extending over an arc located downstream of the main axis of the outlet orifice, relative to the swirling motion, the notched portion is generally crescent-shaped symmetrical about an axis (C) passing through the center of the outlet orifice associated and which is oriented tangentially to the vertical motion.

The present disclosure is directed, at least in part, to improving or overcoming one or more aspects of prior systems.

### SUMMARY OF THE DISCLOSURE

According to a first aspect of the present disclosure a cylinder head of a static spark-ignited gas engine may comprise at least two exhaust ports and at least two inlet ports. The cylinder head may further comprise at least one cylinder axis and each inlet port may have a valve seat for inlet valves, each of said valve seats having a center axis. At least one inlet port may have a countersink in a border area of the bottom side of the cylinder head. The countersink may have an offset axis shifted from said center axis effecting a swirl flow, wherein a radius RF, RF′ of said countersink has a point M, M′, said point M, M′ being a radial maximum with reference to the center axis. A straight line MG, MG′ may virtually connect the cylinder axis with the center axis of the valve seat of one of the inlet ports. The radius RF, RF′ and the straight line MG, MG′ may include an angle φ, wherein said angle φ may fulfill the following condition: 70°<=φ<=110°. Such a cylinder head of a static spark-ignited gas engine may generate a more intense swirling motion in the cylinder.

According to another aspect of the present disclosure a method of manufacturing a cylinder head of a static spark-ignited gas engine may comprise the steps of providing a cutting tool having a tool axis and a cone angle α; the cone angle α being between 45° and 70°, engaging the cutting tool with the inlet port for shaping the countersink, and inclining the tool axis to the center axis about a set angle β, the set angle β being between 2° and 5°.

According to a further aspect a static spark-ignited gas engine may comprise a cylinder head as disclosed herein.

Finally, according to another aspect a method of operating a static spark-ignited gas engine as disclosed herein may comprise the step of applying a high scavenging pressure Δp_{E-A}, wherein Δp_{E-A} fulfills the following condition: 500 mbar<=Δp_{E-A}<=1000 mbar.

Other features and aspects of this disclosure will be apparent from the following description and the accompanying drawings.

### BRIEF DESCRIPTION OF THE DRAWINGS

Other potential advantages and further details of the disclosure are explained in the claims and in the description and shown in the figures in which:

FIG. 1 shows a schematic diagram of a cylinder head with swirl countersinks;

FIG. 2 shows a cross-section of view II-II from FIG. 1;

FIG. 3 shows a lateral view of the piston;

FIG. 4 shows a schematic diagram of a spark-ignited internal combustion engine with a piston, a crankshaft and a camshaft.

### DETAILED DESCRIPTION

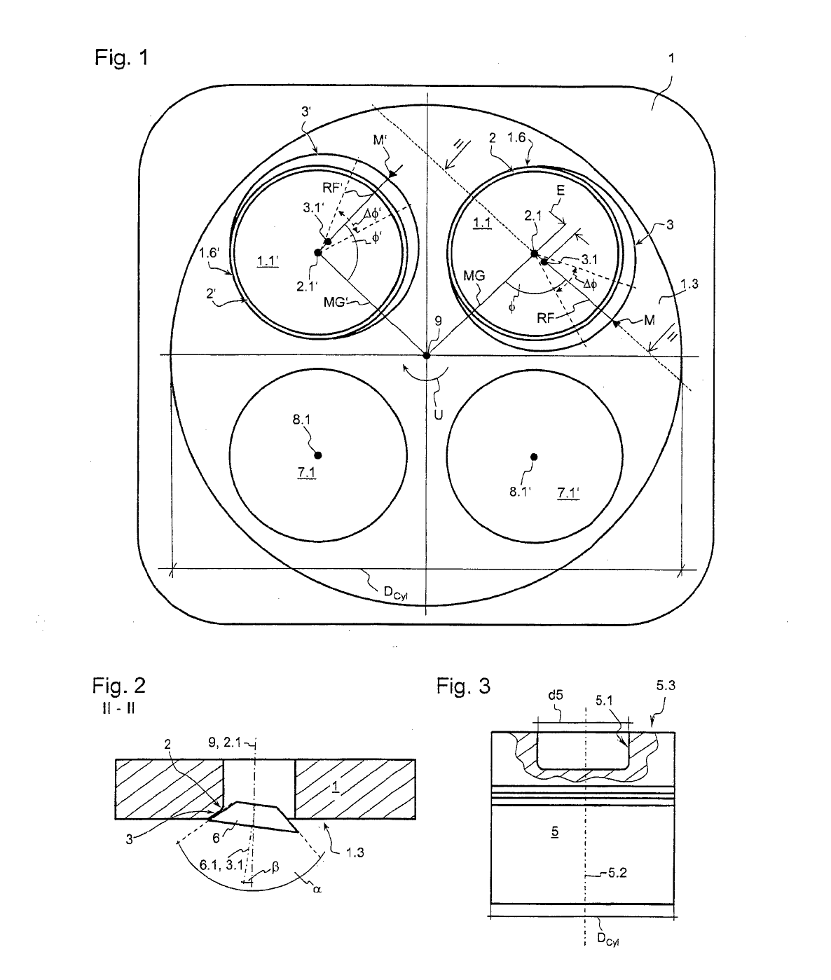

The cylinder head 1 shown in FIG. 1 comprises two inlet ports 1.1, 1.1′ and two exhaust ports 7.1, 7.1′. The respective ports 1.1-7.1′ open into the bottom side 1.3 of the cylinder head 1, whose diameter D_{Cyl} corresponds to the diameter of a combustion chamber 10.3 not shown here and caps this combustion chamber 10.3.

The respective inlet port 1.1, 1.1′ comprises a valve seat 2, 2′ and a center axis 2.1, 2.1′ that corresponds to a valve axis not shown here. The respective inlet port 1.1, 1.1′ comprises a countersink 3, 3′ in a border area 1.6, 1.6′ between the inlet port 1.1, 1.1′ and said bottom side 1.3. The respective countersink 3, 3′ comprises a offset axis 3.1, 3.1′ that is offset at a spacing in radial direction from the center axis 2.1, 2.1′. The spacing thus defines an eccentricity E on the countersink 3, 3′ with reference to the center axis 2.1, 2.1′ of the valve seat 2, 2′.

The countersink 3, 3′ thus formed has the shape of a sickle and comprises a point M that constitutes the maximum distance from the center axis 2.1, 2.1′. A straight line connecting the center axis 2.1, 2.1′ and the point M, M′ will hereinafter be called the radius RF.

The bottom side 1.3 of the cylinder head 1 comprises a center axis that forms the cylinder axis 9. A straight line connecting the cylinder axis 9 and the respective center axis 2.1, 2.1′ will hereinafter be called the straight line MG.

The respective radius RF, RP and the respective straight line MG, MG′ include an angle φ, φ′, said φ, φ′ being plotted counterclockwise from the straight line MG, MG′ such that the first countersink 3 or the radius RF is located with reference to the straight line MG on the side of the adjacent exhaust port 7.1 while the connecting radius RFφ is located with reference to the straight line MG′ on the side of the adjacent inlet port 1.1. Thus the respective radius RF, RF′ is arranged tangentially with reference to a peripheral direction U of the round bottom side 1.3 reflecting the cylinder shape.

Both angles φ, φ′ may have an angle variation Δφ, Δφ′ of up to 20°. It is preferred that the angle φ, φ′ is 90°.

The gas flow entering the inlet port 1.1, 1.1′ through a lesser open valve is diverted by the countersink 3, 3′ in the peripheral direction U.

The respective exhaust port 7.1, 7.1′ comprises a center axis 8.1, 8.1′ of seats for outlet valves not shown here.

The cylinder head 1 according to FIG. 1 is intended for a single cylinder. It is possible within the scope of the disclosure to design a cylinder head 1 with multiple bottom sides 1.3, each of which capping a cylinder or combustion chamber 10.3.

The cross sectional view II-II according to FIG. 2 shows the area of the inlet port 1.1 with the center axis 2.1 which is congruent with the cylinder axis 9 with reference to the alignment shown. To produce the countersink 3, a countersinking tool 6 is used like a milling tool which is inclined about a set angle β to the center axis 2.1 with reference to a tool axis 6.1. The countersinking tool 6 itself comprises a cone angle α. The eccentricity E mentioned above results from the inclination of the countersinking tool 6 about the set angle β, as can be seen in FIG. 2. Alternatively, the countersinking tool 6 can be positioned without an inclination about a set angle β, just by placing it at an offset to the center axis 2.1 corresponding to the eccentricity E, wherein the tool axis 6.1 is parallel to the center axis 2.1.

In accordance with FIG. 3, the piston 5 used in the spark-ignited gas engine comprises a piston crown bowl 5.1 that is pot-shaped. The piston crown bowl 5.1 has a diameter d5 that is about 50% of a piston diameter D_{Cyl}. The piston crown bowl 5.1 is arranged coaxially with reference to the piston axis 5.2. This results in a piston border 5.3, the width of which being about 25% of the diameter D_{Cyl} if the diameter d5 is as mentioned above.

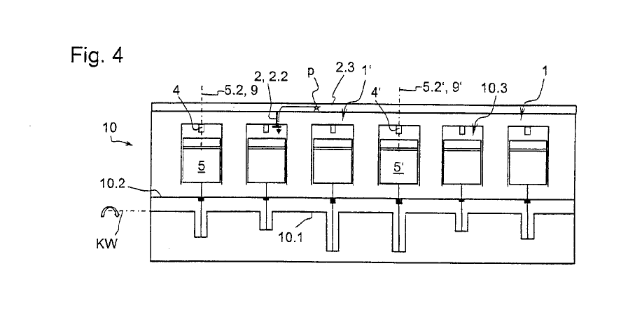

According to FIG. 4, the spark-ignited gas engine 10 shown here in a schematic view comprises multiple pistons 5, 5′ with piston axis 5.2, 5.2′ guided in multiple individual cylinders with cylinder heads 1, 1′ that define a combustion chamber 10.3 together with the respective cylinder or cylinder head 1. A spark plug 4, 4′ designed as a chamber plug is located in the combustion chamber 10.3 where it is typically placed symmetrically to the piston axis 5.2 or the cylinder axis 9, 9′. The second cylinder head 1 in Fig. f shows an example of an inlet valve 2.2 via which a fuel-air mixture can enter the combustion chamber 10.3. The fuel-air mixture is mixed inside a common intake pipe (central feed and mixing line) 2.3. A place p of external cooperation is within the common intake pipe 2.3. Valve timing is performed or applied by a respective camshaft 10.2 by respectively capturing the crankshaft angle KW of a crankshaft 10.1.

### INDUSTRIAL APPLICABILITY

According to the present disclosure a more intense swirling motion in the cylinder may be achieved by providing eccentric countersinks underneath the two inlet ports. The orientation of these countersinks may be such that a rotation of the charge in the cylinder is generated that reinforces the swirling motion generated in the inlet ports. The countersinks of chamfers will herein be referred to as ‘swirl countersinks’.

One characteristic might be the orientation of said swirl countersinks towards the cylinder wall at the angle φ mentioned above such that a swirling motion is generated through interaction with the curvature of the cylinder wall. It might be advantageous if the countersink is at a specific minimum distance from the cylinder wall so that the flow to be introduced or the air-gas mixture, respectively, will not run against the cylinder wall.

The function of the swirl countersinks might be described in more detail as follows. The swirl countersinks perhaps are predominantly effective with small valve lifts, that is, when the valves open and close, since the outflow from the inlet port is forced towards the countersink in this valve position. This results in a high peripheral speed component that translates into a high swirl number in the lower valve area. If the valve lift is large, the outflow from the inlet port primarily flows along the valve axis and might be hardly influenced by the countersink.

The swirl countersink might be only possible with a valve recess, i.e. if the valve head is not flush with the cylinder head bottom but somewhat sunk into it.

The advantages of swirl countersinks might include the following. The countersinks effect improved combustion which may manifest itself in increased efficiency, improved lean-mixture driveability, reduced knocking tendency, reduced spontaneous ignition tendency, and improved cylinder-specific control.

The efficiency of the measure might′ be good, the motion of the charge might be considerably increased without unacceptable impairment of the delivery ratio. The countersink can be introduced into series production without requiring any other re-designing of the cylinder head. The eccentric countersink might be implemented at almost no extra manufacturing costs.

It can also be advantageous if φ=90° or 80°<=φ<=100°.

Another increase in swirl flow might be achieved if both inlet ports have a countersink, wherein an angle φ′ between said radius RF′ and said straight line MG′ fulfills the following condition: 70°<=φ′<=110°, said radius RF being directed to the adjacent exhaust port and said radius RF′ being directed to the adjacent inlet port, both with reference to a circumferential direction U of the cylinder axis.

It might also be advantageous if 80°<=φ′<=100° or φ′=90°. These angles have proven to be very good.

According to the present disclosure, either just one inlet port or both inlet ports comprise a swirl countersink. At least the inlet port can be designed as a tangential port such that the flow into the combustion chamber occurs in tangential direction to the central axis of the cylinder. The swirl countersinks then support or boost this tangential flow.

One of the two inlet ports may be designed as a spiral port that generates at least a local swirling motion that is limited to the area of the respective inlet port. The countersink can expand the latter to the entire combustion chamber.

Advantageously, an eccentricity E between said offset axis and said center axis may fulfill the following condition: 0.005<=E/D_{Cyl}<=0.05, wherein D_{Cyl} is the diameter of a combustion chamber wall, said chamber wall being in part composed of said bottom side of the cylinder head. The eccentricity E of the swirl countersinks helps achieve a considerable intensification of the swirl without unacceptably impairing the throughput of the inlet ports. The eccentricity E should not be selected too large, considering the distance to the cylinder wall.

It can further be advantageous if the ratio of eccentricity E to the diameter of a combustion chamber wall is 0.01<=E/D_{Cyl}<=0.04.

It can also be advantageous if |φ|=|φ′| or |φ−φ′<=20° or |φ−φ′<=15°. The two angles may deviate from one another by up to 20° without the occurrence of drastic disadvantages for the flow. It is preferred that they are of about equal size.

Furthermore, a procedure for manufacturing a cylinder head of a static spark-ignited gas engine as described above can be advantageous wherein a cutting tool is used for manufacturing the countersink, the cutting tool having a tool axis and a cone angle α, said tool being engaged with the inlet port for shaping the countersink, said tool axis being inclined to said center axis about a set angle β, said cone angle α being between 45° and 70° and said set angle β being between 2° and 5°. This combination has proven to be very advantageous.

The advantages according to the present disclosure might also achieved using a static spark-ignited gas engine with a cylinder head as described above.

A particularly high swirl flow is achieved if there is at least one piston, said piston having a piston axis and a pot-like piston crown bowl. If the pot-shaped piston crown bowl is placed coaxial to piston axis, there are symmetrical conditions, especially concerning a squish current, generated between the piston crown bowl and a border of the piston. The swirl flow generated on the inlet side can be particularly optimally utilized for combustion in a spark-ignited gas engine if the engine comprises the squish current generating piston crown bowl described above.

Excellent results might be achieved if a diameter d5 of said piston crown bowl is between 40% and 60% or between 45% and 56% of D_{Cyl}, wherein D_{Cyl} is the diameter of the combustion chamber wall, said chamber wall being in part composed of said bottom side of the cylinder head.

It can further be advantageous if there is a spark plug with a pre-chamber, i.e. a pre-chamber spark plug or a chamber plug. It may happen that the center flame between the spark plug electrodes is blown out by increased swirl flow and squish current. But this can be avoided by using said chamber plug. The chamber plug shields the ignition site from the current in the combustion chamber and creates its own defined ignition conditions. A high swirl flow and squish current primarily affects combustion in the main combustion chamber and not the sensitive ignition phase in the spark plug pre-chamber. No limits are therefore set for a more intense movement of the charge in the combustion chamber.

It can also be advantageous if there is a place p of external carburation of gas and air, said place p being upstream of said valve seat. The swirl flow just has to ensure distribution in the combustion chamber. The gas-air mixture is already mixed when it enters the combustion chamber.

Also advantageous is a procedure for running a static spark-ignited gas engine as describes before, in which a high scavenging pressure Δp_{E-A} is applied, wherein Δp_{E-A} fulfills the following condition: 500 mbar<=Δp_{E-A}<=1000 mbar. A high scavenging pressure drop between inlet and exhaust ports is advantageous for static charged gas engines. This ensures that a strong flow is generated when the inlet valves are opened until the pressure ratio has balanced. The swirl countersinks have a particularly strong effect in this case.

A good swirl flow might be achieved if a Miller valve timing, i.e. Miller cycle timing is applied, in which a crankshaft angle KW at the time the inlet valves nearly close fulfills the following condition: KW>=20° before BDC, with a valve lift of 1 mm. In gas engines with Miller valve timing, the inlet valves already close while the piston is still moving towards the bottom dead center. This once again creates a strong flow in the inlet port outlets when the valves are closing. This is why the combination of the swirl countersinks and Miller valve timing is particularly effective.

In summary, optimum effect of the swirl countersinks and improvement of the combustion process in a charged spark-ignited gas engine are ensured by a high scavenging pressure drop, use of Miller valve timing, a squish current generating piston crown bowl, and/or a chamber plug.

Although the preferred embodiments of this disclosure have been described herein, improvements and modifications may be incorporated without departing from the scope of the following claims.

1. A cylinder head of a static spark-ignited gas engine, the cylinder head comprising:
at least one cylinder axis;
a bottom side;
at least two exhaust ports;
at least two inlet ports which run to the bottom side of the cylinder head, each inlet port having a valve seat for an inlet valve, and each valve seat having a corresponding center axis; and
wherein, among the inlet ports, at least a first inlet port has a first countersink in a border area of the bottom side of the cylinder head, said first countersink having a first offset axis shifted from said corresponding center axis, said first countersink also having a maximum radius with reference to the center axis, said maximum radius and a first straight line forming a first angle φ, said first straight line connecting said cylinder axis with said corresponding center axis, and said first angle φ fulfilling the following condition: 70°<=φ<=110°.

2. The cylinder head according to claim 1, wherein:
80°<=φ<=100°.

3. The cylinder head according to claim 1, wherein a second inlet port has a second countersink, and a maximum radius of the second countersink and a second straight line form a second angle φ′ fulfilling the following condition: 70°<=φ′<=110°, said maximum radius of the first countersink being directed to an adjacent exhaust port and said maximum radius of the second countersink being directed to an adjacent inlet port, both with reference to a circumferential direction of the cylinder axis.

4. The cylinder head according to claim 3, wherein 80°<=φ′<=100°.

5. The cylinder head according to claim 1, wherein an eccentricity E between an offset axis and said corresponding center axis fulfills the following condition: 0.005<=E/D_{Cyl}<=0.05, D_{Cyl} being the diameter of a combustion chamber wall, and said chamber wall being in part composed of said bottom side of the cylinder head.

6. The cylinder head according to claim 5, wherein 0.01<=E/D_{Cyl}<=0.04.

7. The cylinder head according to claim 6, wherein |φ−φ′|<=20°.

8. A method of manufacturing a cylinder head, wherein the cylinder head includes an inlet port that has center axis and a countersink, the method comprising:
providing a cutting tool, the cutting tool having a tool axis and a cone angle α, wherein the cone angle α is between 45° and 70°;
engaging the cutting tool with the inlet port for shaping the countersink; and
inclining the tool axis to the center axis about a set angle β, wherein the set angle β is between 2° and 5°.

9. A static spark-ignited gas engine comprising:
a cylinder head, the cylinder head being configured to include:
at least one cylinder axis;
a bottom side;
at least two exhaust ports;
at least two inlet ports which run to the bottom side of the cylinder head, each inlet port having a valve seat for an inlet valve, and each valve seat having a corresponding center axis; and
wherein, among the inlet ports, at least a first inlet port has a first countersink in a border area of the bottom side of the cylinder head, said first countersink having a first offset axis shifted from said corresponding center axis, said first countersink also having a maximum radius with reference to the corresponding center axis, said maximum radius and a first straight line forming a first angle φ, said first straight line connecting said cylinder axis with said corresponding center axis, and said first angle φ fulfilling the following condition: 70°<=φ<=110°.

10. The static spark-ignited gas engine according to claim 9, comprising at least one piston, said piston having a piston axis and a pot-like piston crown bowl.

11. The static spark-ignited gas engine according to claim 10, wherein a diameter of said piston crown bowl is between 40% and 60% of D_{Cyl}, and D_{Cyl} is the diameter of the combustion chamber wall, said chamber wall being in part composed of said bottom side of the cylinder head.

12. The static spark-ignited gas engine according to claim 11 having a pre-chamber spark plug.

13. The static spark-ignited gas engine according to claim 9, having a place of external carburation of gas and air, said place being upstream of said valve seat.

14. A method of running the static spark-ignited gas engine according to claim 9, the method comprising applying a high scavenging pressure Δp_{E-A}, wherein Δp_{E-A} fulfills the following condition: 500 mbar<=Δp_{E-A}<=1000 mbar.

15. The method of claim 14, wherein a Miller cycle timing is applied, and a crankshaft angle KW at the time the inlet valves closely fulfills the following condition: KW>=20° before BDC, with a valve lift of 1 mm.

16. The cylinder head according to claim 1, wherein
a second inlet port has a second countersink, and a maximum radius of the second countersink and a second straight line form a second angle φ′ fulfilling the following condition: 70°<=φ′<=110°, the maximum radius of the first countersink being directed to an adjacent exhaust port and the maximum radius of the second countersink being directed to an adjacent inlet port, both with reference to a circumferential direction of the cylinder axis; and
an eccentricity E between an offset axis and said corresponding center axis fulfills the following condition: 0.005<=E/D_{Cyl}<=0.05, D_{Cyl} being the diameter of a combustion chamber wall, and said chamber wall being in part composed of said bottom side of the cylinder head.

17. The cylinder head according to claim 16, wherein 0.01<=E/D_{Cyl}<=0.04.

18. The cylinder head according to claim 17, wherein |φ−φ′|<=20°.

19. The static spark-ignited gas engine according to claim 9 having a pre-chamber spark plug.

20. The static spark-ignited gas engine of claim 9, wherein the cylinder head is configured to further include:
a second inlet port, the second inlet port having a second countersink, a maximum radius of the second countersink and a second straight line forming a second angle φ′ fulfilling the following condition: 70°<=φ′<=110°, the maximum radius of the first countersink being directed to an adjacent exhaust port and the maximum radius of the second countersink being directed to an adjacent inlet port, both with reference to a circumferential direction of the cylinder axis.
